(19) United States
(12) Patent Application Publication
(10) Pub. No.: US 2006/0213859 A1
(43) Pub. Date: Sep. 28, 2006

(54) Flatulence-resisting nursing bottle air cap

(76) Inventor: Miin-Tsang Sheu, Changhua City (TW)

Correspondence Address: TROXELL LAW OFFICE PLLC, SUITE 1404, 5205 LEESBURG PIKE, FALLS CHURCH, VA, 22041, US

(21) Appl. No.: 11/088,789

(22) Filed: Mar. 25, 2005

(51) Int. Cl. A61J 9/00; A61J 9/04

(52) U.S. Cl. 215/11.5; 215/11.4

(57) ABSTRACT

The present invention provides a kind of air cap, which has a liquid locking mouth, was designed at the upper part of mouth of nipple and can be locked and positioned at the lower part of nipple with the locking cap of nipple, featuring: a folded air passageway downwards through the lower part from the side was designed at the top edge of air cap, in which a tube, which extends to nearly the bottom of nursing bottle and whose end can be designed as a close air inlet clack valve, was designed at the bottom of air passageway, accordingly, the exterior air can access to the bottle through the locking gap of locking cap of nipple and outer thread at the top section of nursing bottle, and the air refilled in the nursing bottle can run away from the interior liquid passageway of nipple and can be separated from the liquid bottom area of the nursing bottle effectively. Therefore, the air access and air bubble can be avoided effectively and infants would not suck more air and keep them away from flatulence.

### BACKGROUND OF THE INVENTION

1) Field of the Present Invention

The present invention provides a kind of Flatulence-resisting Nursing Bottle Air Cap, particularly a kind of one which has a liquid locking mouth over the mouth of nursing bottle at the middle, and nipple locking cap will lock the positioned air cap, in which, a folded air passageway downwards through the lower part from the side was designed at the top edge of air cap. And a tube, which extends to nearly the bottom of nursing bottle and whose end can be designed as a close air inlet clack valve, was designed at the bottom of air passageway, so that the exterior air can access to the bottle through the extension tube and infants would not suck more air and keep them away from flatulence.

2) Description of the Prior Art

Generally, nipple is locked at the upper part of nursing bottle by a locking cap, so that infant can keep it in mouth and suck the liquid in the nursing bottle. In which, for the balanced pressure in the nursing bottle, the liquid can be sucked successfully. Therefore small air holes were designed, that makes the exterior air can access to the bottle properly through the air holes during sucking and achieve balanced pressure.

However, because the liquid passageway at the interior of the nipple would form liquid absorping area with strong absorping force during the nipple is sucked, accordingly the exterior air will stay around the passageway and will be sucked by the infant with liquid, and causes that the infant suffers from flatulence and discomfort.

For this purpose, there were lots of prior innovation and patents aiming at bettering bottle structure to prevent infants from flatulene. However, for the implementation of the prior patents, some conditions should be provided, i.e. the original nursing bottle should be refitted for meeting with the structure designed specially. Accordingly, that would cause the original nipple or nursing bottle used or purchased would be of being no longer in use and make waste severely. Particularly, mostly infants would not be adaptive to the new nursing bottle or nipple with different structure during taking food.

### SUMMARY OF THE INVENTION

The present invention mainly provides a kind of air cap, which has a liquid locking mouth, was designed at the upper part of mouth of nipple and can be locked and positioned at the lower part of nipple with the locking cap of nipple. A folded air passageway downwards through the lower part from the side was designed at the top edge of air cap, in which an extension tube which extends to nearly the bottom of nursing bottle was designed at the bottom of air passageway, accordingly, the exterior air can access to the bottle through the locking gap of locking cap of nipple and outer thread at the top section of nursing bottle, accordingly, the air refilled in the nursing bottle can run away from the interior liquid passageway of nipple and can be separated from the liquid bottom area of the nursing bottle. Therefore the air access and air bubble can be avoided effectively and infants would not suck more air and keep them away from flatulence. And there is no need to replace the original nursing bottle but to provide additional handy and favorable air cap that has the function in flatulence resistance.

Additionally, the end of air passageway can be bulged outwards as short tube which can extend to the bottle bottom enough, and an extension tube would be interlinked at its periphery, so that the tube can be disassembled, cleaned or replaced conveniently, and convenient maintenance and good sanitary effects on application would be obtained.

### BRIEF DESCRIPTION OF THE DRAWINGS

FIG. 1 is the three-dimensional disassembly diagram of the present invention (including structure example).

FIG. 1-A is three-dimensional diagram of Structure Example I of air cap as reference.

FIG. 1-B is three-dimensional diagram of Structure Example II of air cap as reference.

FIG. 2 is the three-dimensional assembly diagram of the present invention.

FIG. 3 is the assembly cutaway view of Structure Example I of the present invention.

FIG. 3-A is the partial amplified cutaway view of Structure Example II of the present invention.

FIG. 3-B is the function sketch map of Structure Example I of the present invention.

FIG. 4 is the assembly cutaway view of Structure Example II of the present invention.

### DETAILED DESCRIPTION OF THE PREFERRED EMBODIMENTS

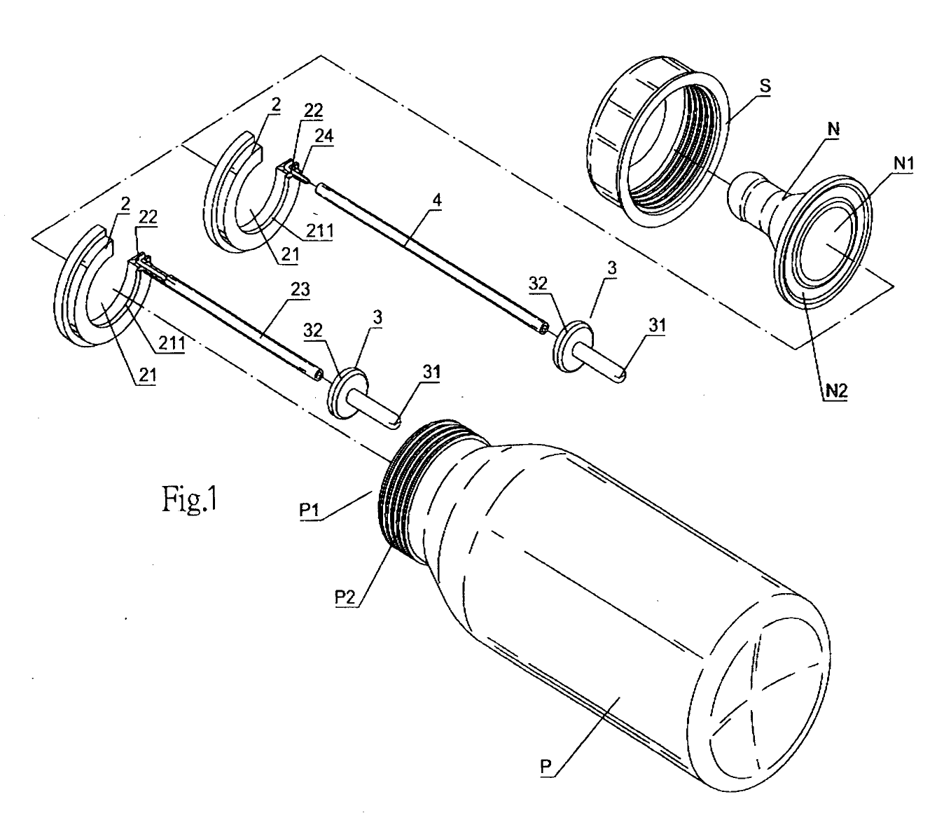

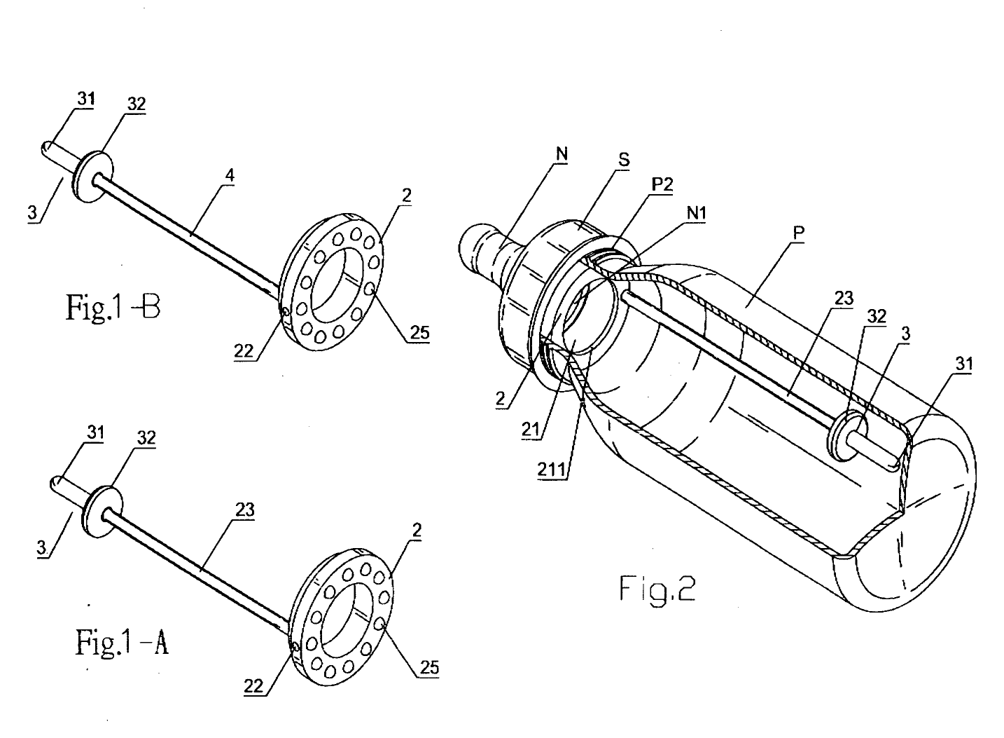

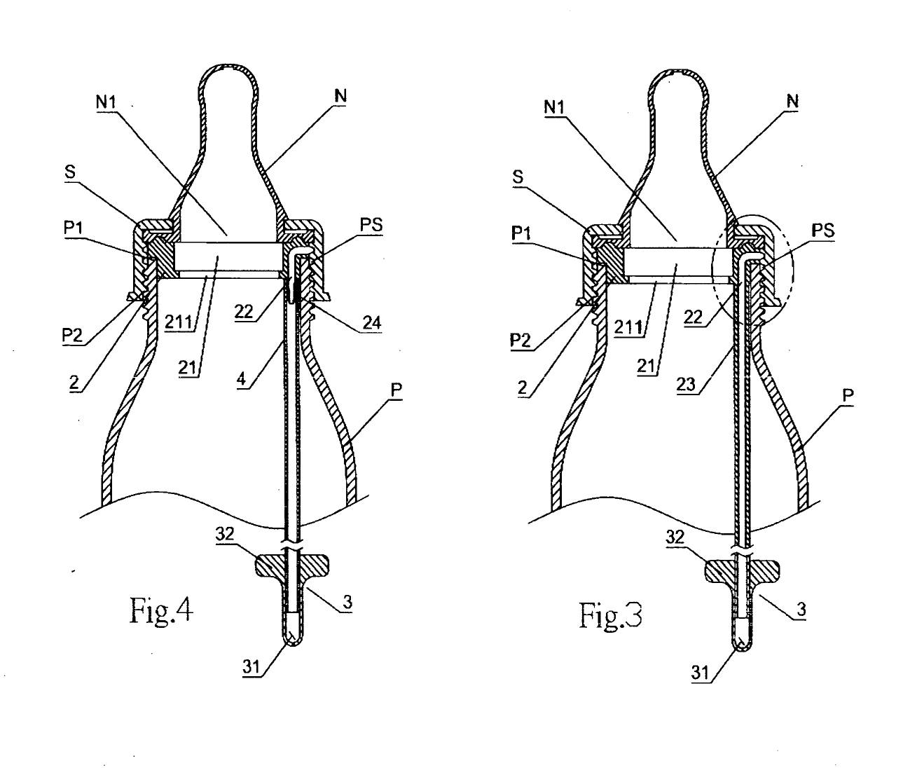

Please refer to FIG. 1, FIG. 1-A, FIG. 2 and FIG. 3 for the structure and embodiment of the present invention: an air cap 2, which has a liquid locking mouth 21, was designed at the upper part of mouth P1 of nipple P and can be locked and positioned at the lower part of nipple N with the locking cap S of nipple S, featuring:

A folded air passageway 22 downwards through the lower part from the side was designed at the top edge of air cap 2, in which an extension tube 23 which extends to nearly the bottom of nursing bottle was designed at the bottom of air passageway 22, accordingly, the exterior air can access to the bottle through the locking gap PS of locking cap S of nipple N outer thread P2 at the top section P of nursing bottle (as shown in FIG. 3-A and FIG. 3-B). And the pressure in the nursing bottle would be balanced to make the liquid W in the nursing bottle can feed towards nipple N continually through the liquid locking mouth 21, further air refilled in the nursing bottle can run away from the interior liquid passageway N1 of nipple N and can be separated from the liquid bottom area of the nursing bottle. Therefore, the air access and air bubble can be avoided effectively and infants would not suck more air and keep them away from flatulence.

Additionally, to prevent the liquid W in the nursing bottle flow into the extension tube 23 inversely, a soft valve granule 3 with an air inlet clack valve 31 whose end is close usually is added working in the bottom of extension tube 23, so that when the exterior air enters into the extension tube 23, it can open the air inlet clack valve 21 straightforwardly, pass through and access to the nursing bottle P, and the air inlet clack valve 31 will close again for lacking of pushing pressure, and the liquid in the nursing bottle would fail to flow into the extension tube 23 inversely.

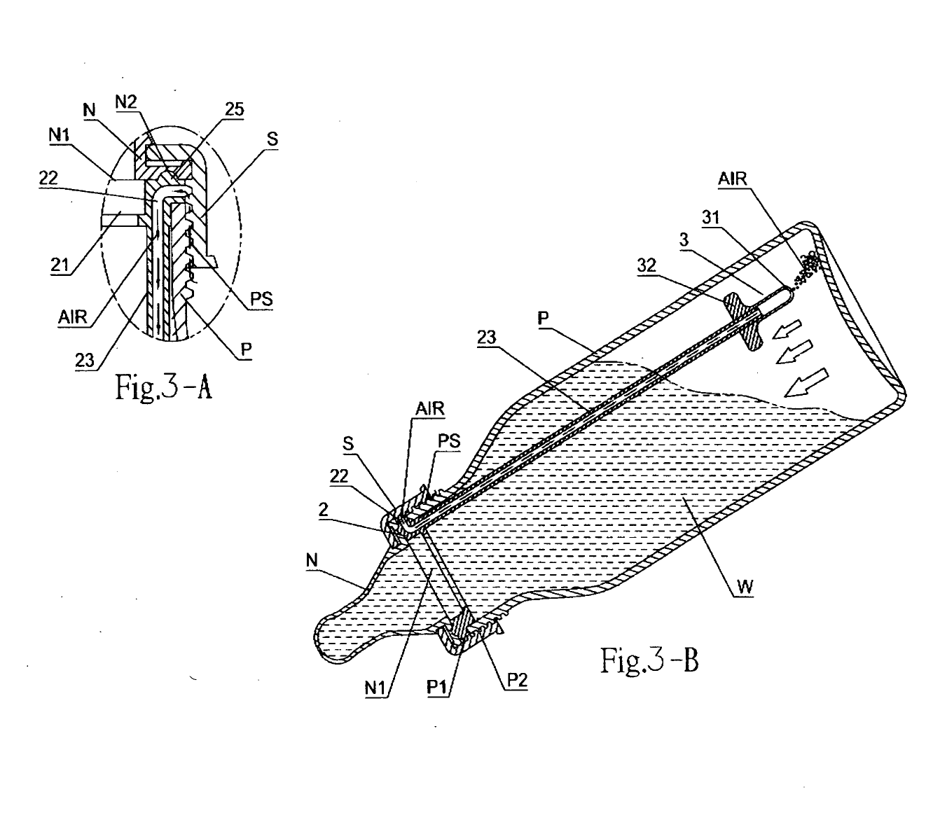

As shown in FIG. 1, FIG. 1-B and FIG. 4: Being equivalent to the extension and air inlet functions of the extension tube 23 abovementioned, the end of air passageway 22 can be bulged outwards as short tube 24, so that a hard extension tube 4 which can extend to the bottle bottom enough is available for locking and position, further based on the coordination of soft valve granule 3 with an air inlet clack valve 31 whose end is close usually designed at the end, the expected function, i.e. the exterior air accessed can be extended, can be obtained.

And as shown in FIG. 1, FIG. 1-A and FIG. 3-A: for the ringy part at the top side of air cap 2, some bulged position points 25 (or position ring etc.) were designed, accordingly, the nipple N will be locked at the upper side of air cap 2 based on the coordination of ringy rabbet N2 designed symmetrically to lower side of nipple N, and the correct correspondence and convenient operation can be realized.

Please refer to FIG. 1, FIG. 1-A and FIG. 2, FIG. 3 and FIG. 3-A: to prevent that the infant will swallow the soft valve granule 3 designed on the extention tube 23, which extends to nearly the bottom of extension tube 23 in the case of unexpected falling, and for easy holding and saving force during cleaing, the upper part of valve granule 3 was designed as broaden holding part 32.

1. A kind of air cap, which has a liquid locking mouth, was designed at the upper part of mouth of nipple and can be locked and positioned at the lower part of nipple with the locking cap of nipple, featuring:
a folded air passageway downwards through the lower part from the side was designed at the top edge of air cap, in which an extension tube which extends to nearly the bottom of nursing bottle was designed at the bottom of air passageway, accordingly, the exterior air can access to the bottle through the locking gap of locking cap of nipple and outer thread at the top section of nursing bottle, and the air refilled in the nursing bottle can run away from the interior liquid passageway of nipple and can be separated from the liquid bottom area of the nursing bottle effectively. Therefore, the air access and air bubble can be avoided effectively and infants would not suck more air and keep them away from flatulence.

2. The Flatulence-resisting Nursing Bottle Air Cap, as recited in claim 1, wherein said, a silica gel or rubber soft valve granule with an air inlet clack valve whose end is close usually was designed at the end of extension tube, accordingly, when the exterior air enters into the extension tube, it can open the air inlet clack valve straightforwardly, pass through and access to the nursing bottle, and the air inlet clack valve will close again for lacking of pushing pressure, and the liquid in the nursing bottle would fail to flow into the extension tube inversely.

3. The Flatulence-resisting Nursing Bottle Air Cap, as recited in claim 1, wherein said, the end of air passageway will extend ourwards to be as short tube, so that a hard extension tube 4 which can extend to the bottle bottom enough is available for locking and position, further based on the coordination of soft valve granule with an air inlet clack valve whose end is close usually designed at the end, the expected function, i.e. the exterior air accessed can be extended, can be obtained.

4. The Flatulence-resisting Nursing Bottle Air Cap, as recited in claim 1, wherein said, for the ringy part at the top side of air cap, some bulged position points or position ring etc. were designed, accordingly, the nipple will be locked at the upper side of air cap based on the coordination of ringy rabbet designed symmetrically to lower side of nipple, and the correct correspondence and convenient operation can be realized.

5. The Flatulence-resisting Nursing Bottle Air Cap, as recited in claim 2, wherein said, to prevent that the infant will swallow the soft valve granule designed on the extention tube, which extends to nearly the bottom of extension tube in the case of unexpected falling, and for easy holding and saving force during cleaning, the upper part of valve granule was designed as broaden holding part.

6. The Flatulence-resisting Nursing Bottle Air Cap, as recited in claim 2, wherein said, for the ringy part at the top side of air cap, some bulged position points or position ring etc. were designed, accordingly, the nipple will be locked at the upper side of air cap based on the coordination of ringy rabbet designed symmetrically to lower side of nipple, and the correct correspondence and convenient operation can be realized.

7. The Flatulence-resisting Nursing Bottle Air Cap, as recited in claim 3, wherein said, for the ringy part at the top side of air cap, some bulged position points or position ring etc. were designed, accordingly, the nipple will be locked at the upper side of air cap based on the coordination of ringy rabbet designed symmetrically to lower side of nipple, and the correct correspondence and convenient operation can be realized.

8. The Flatulence-resisting Nursing Bottle Air Cap, as recited in claim 3, wherein said, to prevent that the infant will swallow the soft valve granule designed on the extention tube, which extends to nearly the bottom of extension tube in the case of unexpected falling, and for easy holding and saving force during cleaning, the upper part of valve granule was designed as broaden holding part.
